(19) United States
(12) Patent Application Publication
(10) Pub. No.: US 2012/0179521 A1
(43) Pub. Date: Jul. 12, 2012

(54) A SYSTEM OF OVERLAYING A TRADE MARK IMAGE ON A MAPPING APPICATION

(76) Inventor: Paul Damian Nelson, South Yarra (AU)

(21) Appl. No.: 13/496,838

(22) PCT Filed: Sep. 20, 2010
(86) PCT No.: PCT/AU2010/001223

§ 371 Date: Mar. 16, 2012

(30) Foreign Application Priority Data
Sep. 18, 2009 (AU) 2009904523
Aug. 30, 2010 (AU) 2010903866

(51) Int. Cl. G06Q 30/02

(52) U.S. Cl. 705/14.4

(57) ABSTRACT

A new invention is shown herein, that is a new method, process, system, or application of communication. This relates to viewing maps via various medium including any maps, for example, GPS navigation, Satellite imagery, printed maps and so on. On such map imagery a new representation form, such a company trade mark is included. A viewer of such a map image can locate an organization via the position of its trade mark on the map. Further, a user can interact with representation trade mark by, for example, clicking mouse over a trade mark on a Satellite image of a map, or on touch pad on “Navman” or “Tom Tom” and in doing so, a pop up menu of more information can show, so the browser could be directed to a designated web site, or further communication material. In other examples, trade marks can be represented on a map that may not relate to the location of the organisation which owns the trade mark. In this instance, independent space can be hired out to a trade mark director, whereby such space with trade mark can then direct browser to designated information as chosen by trade mark director.

### FIELD OF THE INVENTION

This document and the invention referred to herein claim priority of Australian Provisional Applications 2009904523 of 18 Sep. 2009 and 2010903866 of 30 Aug. 2010.

This invention relates to method, process, and application of communication, including use of representation. In particular, this invention relates to such representation of images such as a trade mark or service mark that can appear on a map image.

The map or representation of map can be or relate to any type, form, or system, wherein such mediums can be, or include any relation to print, Satellite, Electronic, Internet, Computer, Telephone, Mobile Telephone, Google Earth, Google Maps, Google Maps Street View, Navman Car GPS, Tom Tom GPS Navigation, or such like.

This invention includes a representation, such as a trade mark or service mark, that can be of any form, including real, illusionary, anamorphic, superimposed, virtual, or the like, or combination of any of these, including method, process, system, or application for communication.

### BACKGROUND OF THE INVENTION

Maps traditionally are designed for mapping area, a specific location, or designation. Examples of map types or forms can include print, Satellite, Electronic, Internet, Computer, Telephone, Mobile Telephone, Google Earth, Google Maps, Google Maps Street View, Navman Car GPS, Tom Tom GPS Navigation, or such like.

Finding and creating space, and real estate for communication representations, such as trade marks and service marks, can be a challenge. Space can be a valuable commodity and limited. The maps mediums referred to herein this document do not include such representations referred to.

As a result, the problems are that such map mediums do not most efficiently utilize the space they have, and the communication with a viewer, or user—that is, by not including trade mark or service mark representation/s that can communicate with viewer.

As some examples to note, advertising a trade mark or service mark on certain large areas such as a mass of water, or land, on top of a building, in space, in air space, in an area not on Earth, can be anywhere from very difficult and expensive, to simply impractical, to say the least.

As a further example to note, advertising on the top of buildings can be an expensive exercise, for example, painting a business name or trade mark on it, and same can be difficult or limited for viewer to see it. One way can be for a viewer to see a sign like this in a particular example would be when an aeroplane is flying over it. In such case the representation is limited for its viewers. Amongst other difficulties, another difficult issue is that the surface area of the roof top would have to be sufficiently big enough to allow representation on it to be easily seen by, for example, a person flying over it [or viewer] in an aeroplane. In an aeroplane the perspective of the viewer is limited and at the subsequent control, at least one would expect, of the pilot.

A further problem with creating or putting a representation on such a roof top is the means, or physical structure and positioning to meet intent of communication exercise or reason.

Often roof tops are odd shaped, and can have other items on them, and painting is usually the easiest and safest method, which though in itself can be costly and dangerous, is still generally more effective than securing a means above it.

Areas such as, roof tops of houses are not normally used because they are too small or insignificant when viewed from an aeroplane, especially in amongst so many others.

Covering grounds with representation, such as for advertising, signage, or landmarks, such as where people can walk, is also a problem, because that is where they may walk.

In sub-object, an area [such as a dessert] could be used to, for example, portray, print, or represent at least an ‘over-scale’ trade make or service. To be visible from a satellite image the space required would be ‘over-sized’ and accordingly commercially costly. In general terms, this means, for example, a large scale image of, for example, “KFC”, in a very large open location, may be somewhat costly to produce, and limited to view by viewing perspective.

Only some basic problems are outlined by way of example here.

It is the object of the present invention to overcome these problems.

### SUMMARY OF THE INVENTION

It is the object of this invention to overcome problems as described, and provide a new method, process, system or application of communication.

This invention includes a series of methods, processes, systems, and applications of using, creating, transforming space, with real, illusionary, anamorphic, virtual relations, or such like, allowing communication.

This invention may be said, in the first aspect, to reside in a method, process, system, or application of communication wherein the representation such as a trade mark or service mark can be represented on a map or a representation of a map, wherein the map or representation of map can be or relate to any type, form, or system, wherein such mediums include such any mediums such as print, photograph, Satellite, Electronic, Internet, Computer, Telephone, Mobile Telephone, Google Earth, Google Maps, Google Maps Street View, Navman Car GPS, Tom Tom GPS Navigation, or such like, and the representation can be at any location, at any size, in any duplication, at any represented space or matter, including Earth, and or non or Earth space, matter, material, or otherwise, and optionally wherein, an interactive system with the representation can lead to further information, such as a designated website, a pop-up menu, and/or further information.

In this way, for example, a person could log onto a computer, log onto the internet, log onto Google Earth, obtain a view of Earth and space, and at any particular location, such in space, or on a country, a company trade mark such as McDonald's could be viewed. This allows for trade mark exposure in a new way, as maps are normally designed for location related information, whereas, with this aspect of the invention, a company trade mark can be integrated into the map anywhere, making the viewing space used more efficient. The browser could scroll their mouse over the trade mark/s, and then a pop-up menu could appear. The pop-up menu could be further information about McDonald's or their products, or in another instance, an advertisement for the latest burger could be shown. In another instance, by clicking the mouse over a trade mark, the browser could be automatically directed to a McDonald's web site, or another of their choosing. This provides an interactive map via a trade mark which enhances value to company. A browser could choose to zoom in anywhere, and to any height, for example, from 11 km height/elevation view, anywhere down to closest possible view to ground, and the trade mark/s could be integrated and be interactive in the map, and be visible at any height/elevation view.

This invention may be said, in the second aspect, to reside in a method, process, system, or application of communication wherein the representation such as a trade mark or service mark can be represented on a map or a representation of a map, wherein the map or representation of map can be or relate to any type, form, or system, wherein such mediums include such any mediums such as print, photograph, Satellite, Electronic, Internet, Computer, Telephone, Mobile Telephone, Google Earth, Google Maps, Google Maps Street View, Navman Car GPS, Tom Tom GPS Navigation, or such like, and the representation can be at any location, at any size, in any duplication, at any represented space or matter, including Earth, and or non or Earth space, matter, material, or otherwise, wherein the location of the representation relates to the location of a product, goods or service, and optionally wherein, an interactive system with the representation can lead to further information, such as a designated website, a pop-up menu, and/or further information.

In this way, as an example, a person could log onto their computer, log onto the internet, Google Earth, or Google Maps, do a search on a company, such Coca Cola, find a location that relates to a location of Coca Cola, choose to then go to such location, be directed to a map relating to Coca Cola, and then instead of simply seeing an old style ‘balloon’ or series of same, one or more trade marks for Coca Cola would be on the map. The browser could scroll their mouse over the trade mark/s, and then a pop-up menu could appear. The pop-up menu could be further information about Coca Cola or their, products, or in another instance, an advertisement for the latest bottle design or drink promotion could be shown. In another instance, by clicking the mouse over a trade mark, the browser could be automatically directed to a Coca Cola web site, or another of their choosing. This provides an interactive map via a trade mark which enhances value to company. A browser could choose to zoom in to anywhere that relates to Coca Cola, and to any height/elevation view, for example, from 11 km height/elevation view, anywhere down to closest possible view to ground, and the trade mark/s would be integrated and be interactive in the map, and be visible at any height/elevation view. Same can apply to use of a navigation system for example.

This invention may be said, in the third aspect, to reside in a method, process, system, or application of communication wherein the representation such as a trade mark or service mark can be represented on a map or a representation of a map, wherein the map or representation of map can be or relate to any type, form, or system, wherein such mediums include such any mediums such as print, photograph, Satellite, Electronic, Internet, Computer, Telephone, Mobile Telephone, Google Earth, Google Maps, Google Maps Street View, Navman Car GPS, Tom Tom GPS Navigation, or such like, and the representation can be at any location, at any size, in any duplication, at any represented space or matter, including Earth, and or non or Earth space, matter, material, or otherwise, wherein the location of the representation may not relate to the location of a product, goods or service, and as such, the representation space may be utilized by a further party, and optionally wherein, an interactive system with the representation can lead to further information, such as a designated website, a pop-up menu, and/or further information.

In this way, for example, a person could log onto a computer, log onto the internet, log onto Google Maps, obtain a view of Earth and space, and at any particular location, such in space, or on a country, a company trade mark such as McDonald's could be viewed. This allows for trade mark exposure in a new way, as maps are normally designed for location related information, whereas, with this aspect of the invention, a company trade mark can be integrated into the map anywhere, yet being in location of another party, such as the roof top of a property, which could be hired out space to McDonald's, making the viewing space used more efficient. The browser could scroll their mouse over the trade mark/s, and then a pop-up menu could appear. The pop-up menu could be further information about McDonald's or their products, or in another instance, an advertisement for the latest burger could be shown. In another instance, by clicking the mouse over a trade mark, the browser could be automatically directed to a McDonald's web site, or another of their choosing. This provides an interactive map via a trade mark which enhances value to company, and further provides ability for another party to hire out their space. A browser could choose to zoom in anywhere, and to any height/elevation view, for example, from 11 km height/elevation view, anywhere down to closest possible view to ground, and the trade mark/s would be integrated and be interactive in the map, to visible at any height/elevation view chosen. Same can apply to use of a navigation system for example.

This invention may be said, in the forth aspect, to reside in a method, process, system, or application of communication of all aspects inclusive, wherein, the representation, and the map or map representation, wherein the map or representation of map can include such any mediums such as print, Satellite, Electronic, Internet, Computer, Telephone, Mobile Telephone, Google Earth, Google Maps, Google Maps Street View, Navman Car GPS, Tom Tom GPS Navigation, or such like, and can have any combination or permutation of the elements and principles of design [as are known in the design industry].

Some further descriptions about the summary of invention follow.

With the availability of the internet users can employ “Google Earth” or “Google Maps” or “Google Street View” and other mapping systems or things.

This brings to the mass market the visible availability of many other roof tops, or even ground tops, that can be viewed, and with more viewing control and discretion.

The advantage of this invention is that many structures including residential houses around the world can then use surface such as tops as real estate for a representation.

In this way, a residential party may be able to receive consideration for use of their roof top, or use it otherwise.

This opportunity is assisted by the application of the internet.

This opportunity is assisted also by aerial viewing perspectives, such as Google Earth, or such like as referred to herein.

This invention can be applied to various forms such as structures, buildings, or grounds, house fronts, sides of structures, and so on.

Safety, security, and rights of use and space, of structures on top of grounds, and tops, for example, is relevant, as is any other relevant rights.

The superimposed image on Google Earth application means that a physical structure does not need to be made and placed over the top of the physical building itself.

Google Earth or any other such portal or system could be used via the internet, and any provider or subsequent programs or applications that work or relate to Google Earth could be part of this system.

Also, by way of having a superimposed image that is virtual, means that by way of the application, other computer related systems can be used in the process.

For example, the trade make could be easily replaced by another image.

Any text may have language that may change from country to country.

A theme of, for example, a country flag or colours, or World Cup Soccer, The Olympics, The Tour De France, or other themes may be connected, for example, by way of design, to connect with changing times, or events.

This could be viewed by a person on the internet using Google Earth, zooming in to the appropriate height above the location.

An internet user has a lot more control in viewing such things, for example, zooming in, printing, panning, and so on.

This give trade mark value to the company, and can be a landmark on the map itself, as well as bring innovative artistic value and psychological recognition and communication to viewer.

This also allows for such visibility to occur without the need for a physical structure over the physical site, referred to herein.

For example, a user looking at the The Coca-Cola Company could log onto the internet, log onto Google, do an internet search for Coca-Cola and find coca-cola.com.

Next a user could log onto http://www.coca-cola.com and find information about Coca-Cola.

A user could find an address for Coca-Cola. A user may wish to see where that is on a map. To assist this process a user could use Google Earth at googleearth.com.

At Google Earth (or googleearth.com) a user could do a search for “The Coca-Cola Company” and the address and location could appear.

A user can then click onto locate such address and be taken to the Coca-Cola company.

Normally, photographic style coloured buildings will be shown, as that is the ‘satellite’ photograph, or such like shown.

This invention would allow a trade mark of Coca-Cola (or “Coke”) to be placed in front of the image a user would be looking at, that is, appear to be superimposed on the top of the ground, or building/s, or areas to aims to allow the trade mark to become an identity of that area, and in doing so to create an environment whereby Coke adds life.

The trade mark could be one such as the following:

The contrast of the photorealistic satellite photo or imagery would be very apparent with the bright trade mark image, thereby emphasizing, the overall impression.

A user could also click the mouse onto the Coke trade mark, which could have a link set up, to then take the user to a web site via such connection.

In this case, the user may be taken to the coca-cola.com web site.

Other examples or embodiments may direct a users connection to a different site, or sites in booking order.

Some directions may be at choice of application or program, whereas other directions may be at the choice of the user via a ‘pop-up’ menu, multiple choice, gradations, scaling, and the like.

This opens up a whole realm of real estate space that may be used, hired, managed, and so on.

This invention includes an innovative and inventive way of creating a real merger between real life satellite photography with non-real, virtual, iconic, or other representations, and internet user interface, and the nexus there between.

This process described can show over a full circle or 360 degree process link from Satellite photo, to search of company on Google Earth, to location of search results on map, to zoom in of location, to then transformation from ‘real life’ image to ‘super real’ or ‘hyper real’ connection of trade mark, to click through that to certain web site, and so on.

The same process and system could shown with many examples.

This is an invention to add significant artistic and commercial value.

This process can be used on any map form, including print, Satellite, Electronic, Internet, Computer, Telephone, Mobile Telephone, Google Earth, Google Maps, Google Maps Street View, Navman Car GPS, Tom Tom GPS Navigation, or such like.

This process can also be used in computer games, that is where photorealistic imagery can be used with non-real imagery.

If used in a computer game, in this example, the artistic elements may be partially reversed, whereby most of the imagery may be non-real, and real representations can be included.

The same principles can apply, as described, but more matter may be non-real imagery, somewhat in reverse to example used with Google Earth and Coca-Cola.

One such example could be say “Ben & Jerry's” Ice-cream, using the following example trade mark:

Another example could be the “Venetian” Hotel in Las Vegas, using the following trade mark examples:

The same principles, method, applications, or systems could apply for these other examples, wherein variations could apply as appropriate to details required.

It is to be noted all references to trade marks herein are for principle purpose referred to herein, and same examples only, and all rights are fully respected.

### BRIEF DESCRIPTION OF THE FIGURES

It is noted that photographs and superimposed imagery is used in these figures which are representational and are not necessary to scale, or proportionate. Any reference to photos or photographs is to be taken as read to include copies, prints, or such like representations of same.

All aspects of the invention referred to in this document are shown by way of example in these Figures.

Some preferred embodiments of the invention are described, by way of example, with reference to the accompanying figures, in which:

FIG. 1 is a copy of a map representation;

FIG. 2 is a copy of a map representation with the invention;

FIG. 3 is a copy of a map representation;

FIG. 4 is a copy of a map representation with the invention;

FIG. 5 is a copy of a map representation;

FIG. 6 is a copy of a map representation with the invention;

FIG. 7 is a copy of a map representation;

FIG. 8 is a copy of a map representation with the invention;

FIG. 9 is a copy of a map representation;

FIG. 10 is a copy of a map representation with the invention;

FIG. 11 is a copy of a map representation with the invention;

FIG. 12 is a copy of a map representation with the invention;

FIG. 13 is a copy of a map representation;

FIG. 14 is a copy of a map representation with the invention;

FIG. 15 is a copy of a map representation with the invention;

FIG. 16 is a copy of a map representation with the invention;

FIG. 17 is a copy of a map representation;

FIG. 18 is a copy of a map representation with the invention;

FIG. 19 is a copy of a map representation with the invention;

FIG. 20 is a copy of a map representation;

FIG. 21 is a copy of a map representation with the invention;

FIG. 22 is a copy of a map representation;

FIG. 23 is a copy of a map representation with the invention;

FIG. 24 is a copy of a map representation;

FIG. 25 is a copy of a map representation with the invention;

FIG. 26 is a copy of a map representation;

FIG. 27 is a copy of a map representation with the invention;

FIG. 28 is a schematic, or process stage flow chart example showing the invention;

FIG. 29 is a schematic, or process stage flow chart example showing the invention; and

FIG. 30 is a schematic, or process stage flow chart example showing the invention.

### DESCRIPTION OF THE PREFERRED EMBODIMENTS

Some preferred embodiments of the invention will be described by way of example to the accompanying figures.

A series of photographs will be shown in sequence to demonstrate the way this invention works by way of comparison of chosen space.

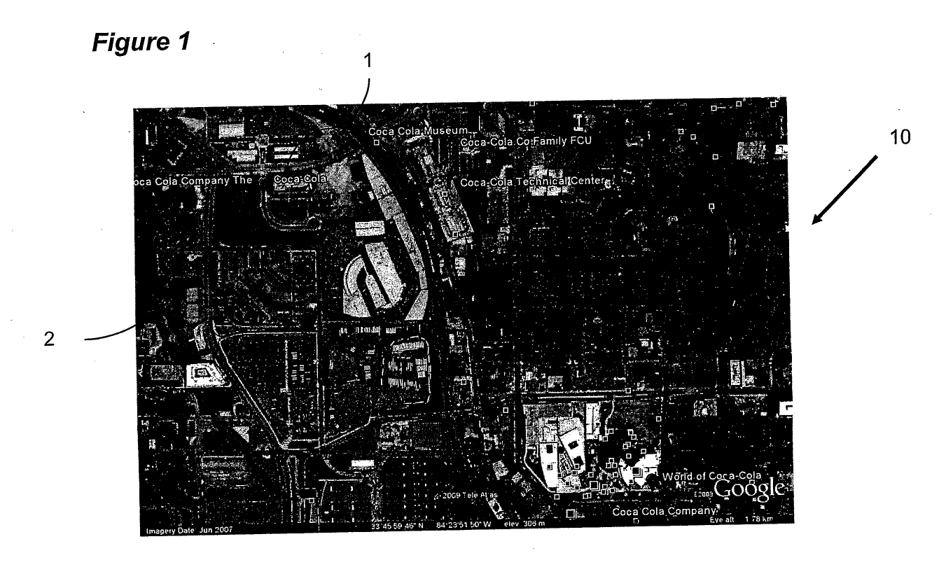

FIG. 1 shows a satellite photograph, representation 10, from Google Earth.

A person could log onto the internet and via Google Earth, do a search on the Company “Coca-Cola”.

A company address for Coca-Cola can then be located, as shown by 1, and other relevant area 2, identifies near by area.

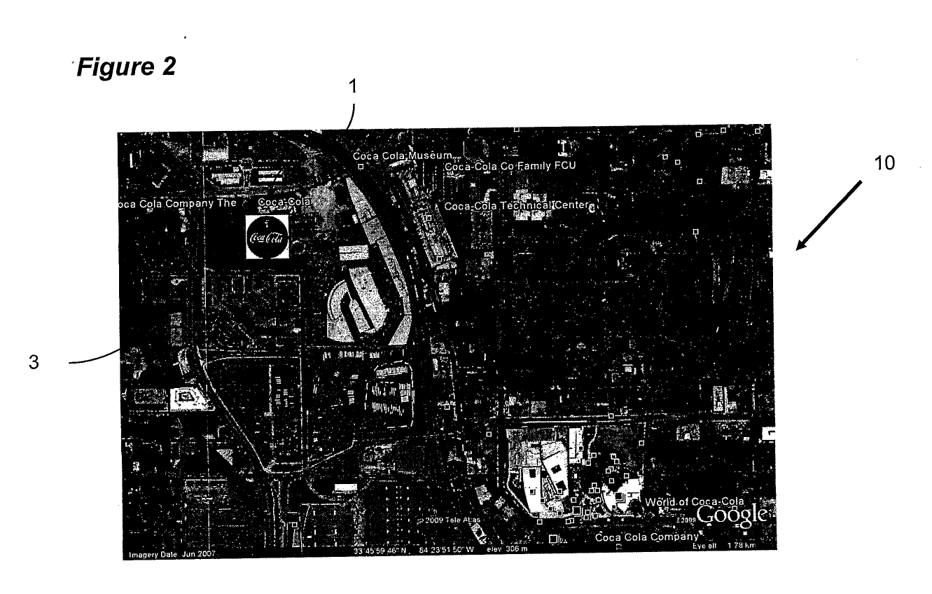

FIG. 2 shows much the same representation of FIG. 1.

FIG. 2 includes a trade mark of “Coca-Cola” 3.

This is a representation of what a user may be able to see on the internet with this invention.

In all examples herein of representations, such as trade marks on maps, the representations can be embedded into map or image to create interactive system as described herein, using methods of embedding and using hyperlinks as is known in the industry.

In this event, a user could locate Coca-Cola not just by text or a ‘balloon’ type pin point as seen in the Google Earth print, but an actual trade mark as referred to.

A user could also click the mouse onto the trade mark and it could go to a link from there, such as coca-cola.com, or to any other link programmed or directed by system, or alternatively, the user could be given a choice by, for example, a pop up question, or other appropriate method for direction.

This is innovative for many reasons referred to, including that a user gets to see a photo realistic satellite photo, then on that, a commercial trade mark.

The juxtaposition of these artistic styles and treatments, give enhanced emphasis to the overall image.

Artistic value can be enhanced.

Perspective or judgement value of viewer is very important, so keeping the artistic and overall image unified in composition of course, is very important.

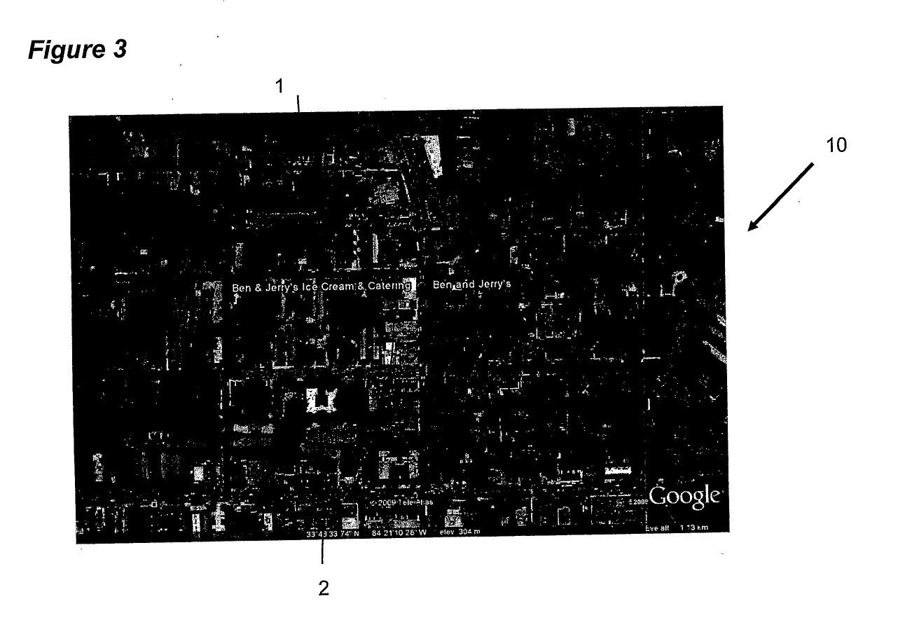

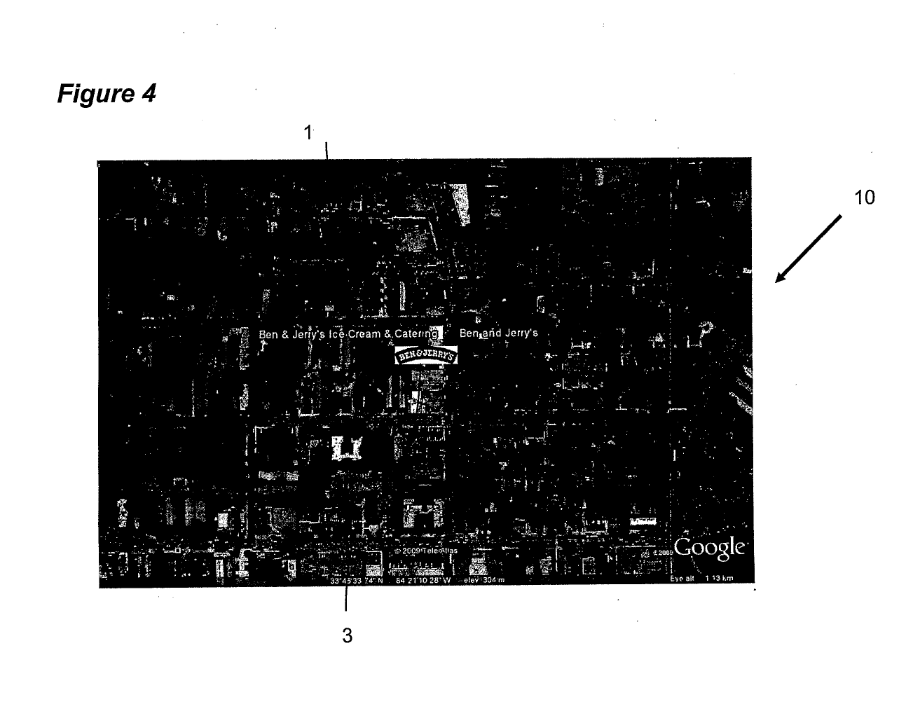

FIGS. 3 and 4 show similar principles and systems as shown in other figures, but with different examples, and artistic composition, means, and layout.

FIG. 3 shows another representation 10 of Google Earth satellite representation, showing business location for “Ben & Jerry's” 1, and near by area 2.

FIG. 4 shows much the same representation of FIG. 3, with satellite representation 10, Ben & Jerry's at 1, and trade mark 3 of Ben & Jerry's.

As described herein, this could be an example representation of what it may look like when a user logs onto the internet, goes onto Google Earth, searches for Ben & Jerry's, goes to their address at satellite representation 10, sees their location 1, and then sees the trade mark 3.

These are examples only, as other search information or direction could be used to arrive at such a site on the internet.

Also, as previously described, the trade mark 3, could allow for a link to other internet links and so on.

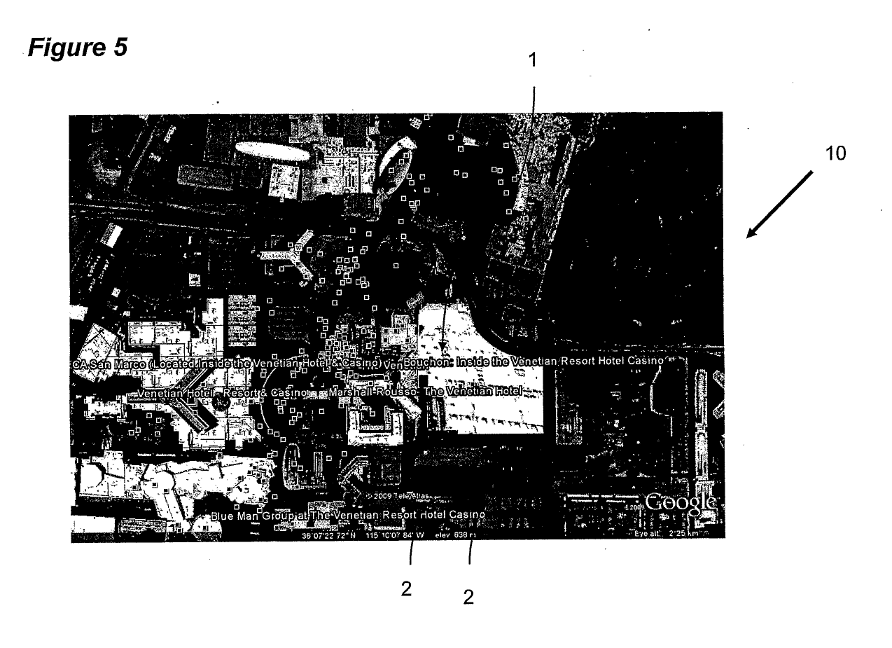

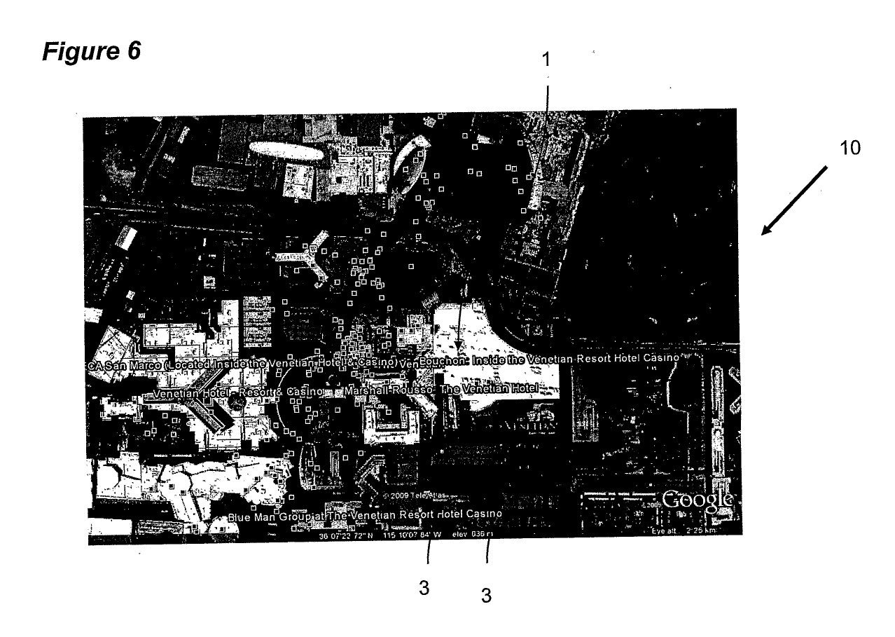

FIGS. 5 and 6 are further examples of the invention as described.

FIGS. 5 and 6 show similar principles, systems, processes, applications, and examples of the invention as shown in other figures, but with different examples, and artistic composition, means, and layout.

FIG. 5 is a satellite representation 10 from Google Earth, with area 1, showing area of or near The Venetian Hotel, and areas 2, areas related to same.

FIG. 6 shows much the same areas and items as FIG. 5, but this FIG. 6 shows two Venetian trade marks 3.

This example demonstrates more than one trade mark being used at a time.

Of course, in all these examples, the trade mark could be in different locations on maps, such as indirect pointers, or so on.

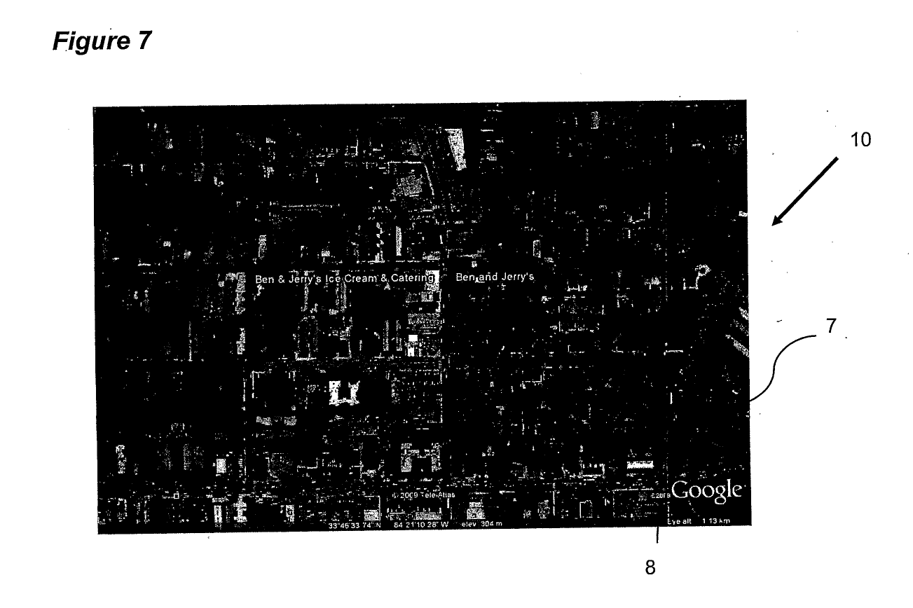

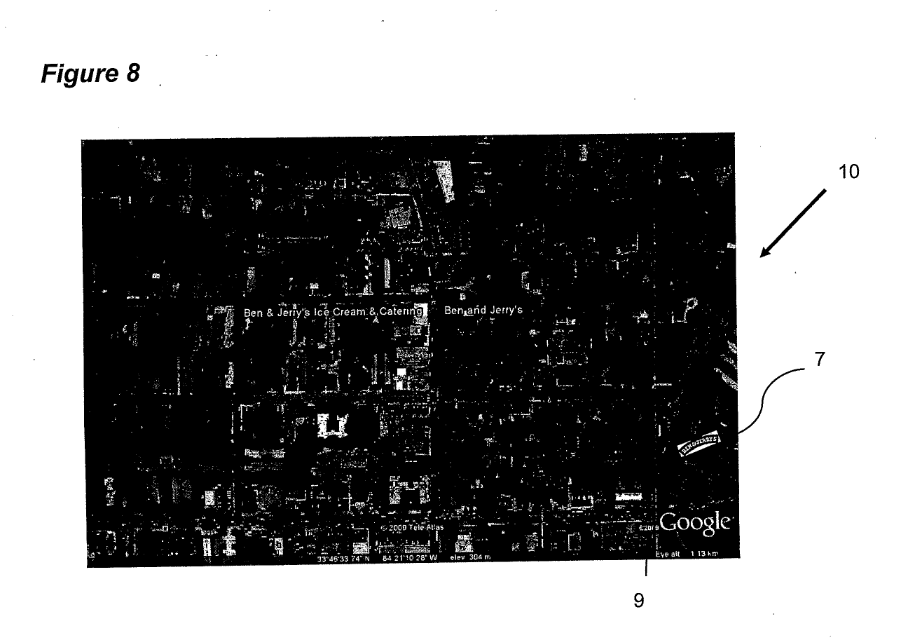

FIGS. 7 and 8 show yet another example of the invention.

FIG. 7 is a representation of a satellite photograph 10 obtained via the internet on Google Earth, with a structure 7, and area near by 8, roof.

FIG. 8 is much the same as FIG. 7 with same references, but in this case, a Ben & Jerry's trade mark can be seen at 9, covering the area 8, as shown in FIG. 7.

In FIG. 8, this way, a virtual representations such as a trade marks, or trade marks, superimposed or otherwise located on map, and or including pop up menus and internet links, could be used on a locations, for example, at private residence, a beach, a stretch of water, or any other location that is not at the designated location or registered address of a company, or party being linked to representation.

This can allow for greater use of space for such chosen representation/s, creating more visual presence, of for example, a company such as Ben and Jerry's, Coca Cola, The Venetian Hotel, or any other company, business, organization, institution, group, individual, party, entity, non-entity, or otherwise.

Further, a hire fee could be paid for the use of such space, or pop up menus, information, etc as previously referred to.

In this case, for example, in FIG. 8, Ben and Jerry's could pay a fee to the party or parties that have rights to visual space at areas 7 and 8 as shown in FIG. 8.

Further examples of the invention will be shown by way of example, using the famous McDonald's trade mark as below, and some representations, in these cases, trade marks, [shown in figures].

Another famous McDonald's trade mark is shown below, which Is an example of alternative of what could be used in the subsequent examples.

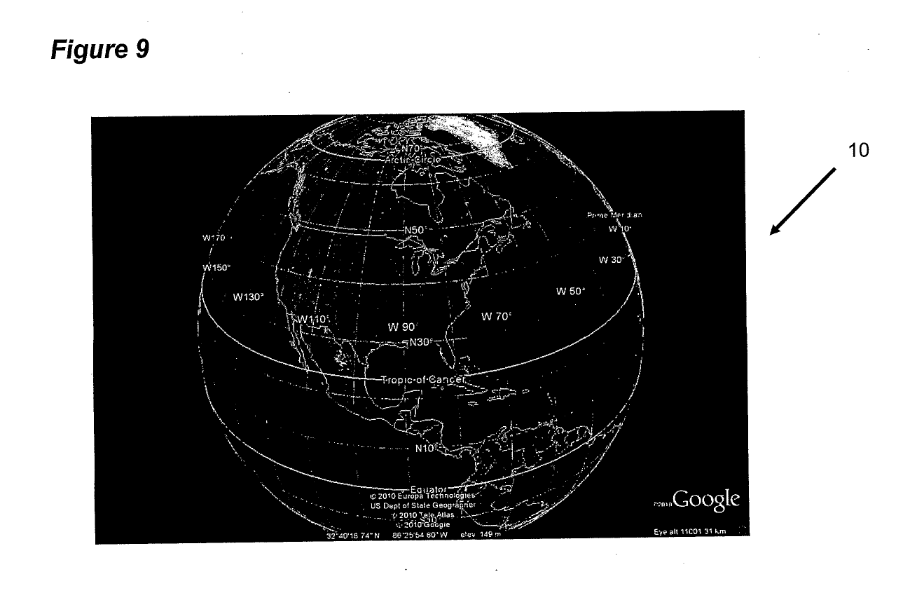

FIG. 9 shows a representation of a map of the world. This is shown as example space as to where the invention could be utilized, that being, any location of the world, visible from any distance away from the ground or surface tops, including as a browser gradually gets closer view to any location, at any point. The images could be, for example, vector images, or otherwise achieving desired result, that will be clear to viewer when viewed from any distance.

In the same way, there could be trade marks on each country around the world.

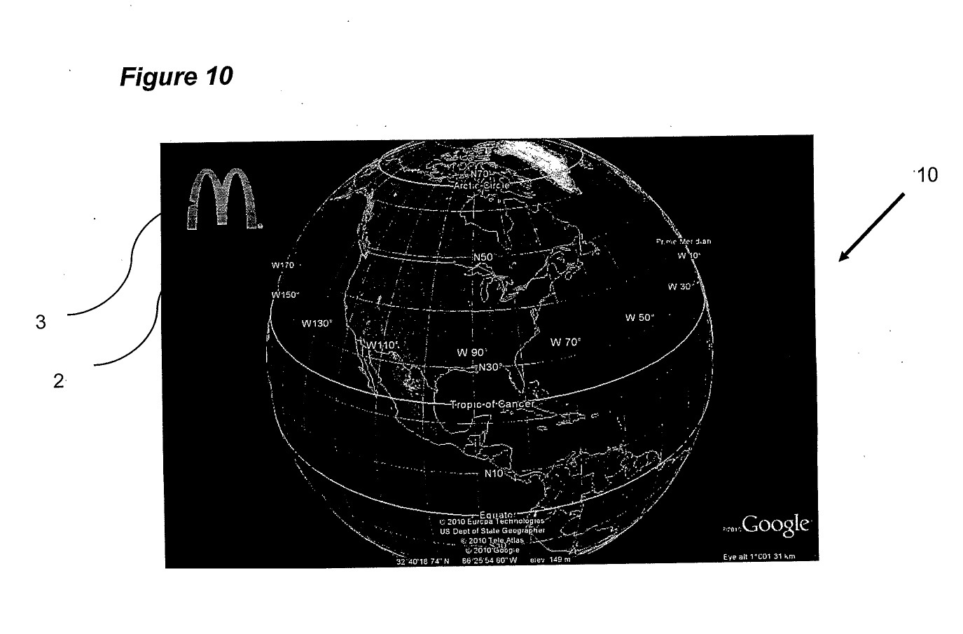

FIG. 10 shows essentially the same figure as 10, however, with the invention shown at 3, with the trade mark shown. Item 2 indicates area around or near by item 3, the trade mark, that can be regarded as negative space, so as to help create artistic unity.

In this way, the trade mark can be seen in outer space. FIG. 10 shows the same image of the Earth as shown in FIG. 9, however, with a McDonald's trade mark located in a position ‘floating in space’. This image floating in space can be a very valuable commodity for such a commerce operation. In the same way, there could be more than one, or many different, or the same trade marks floating in space.

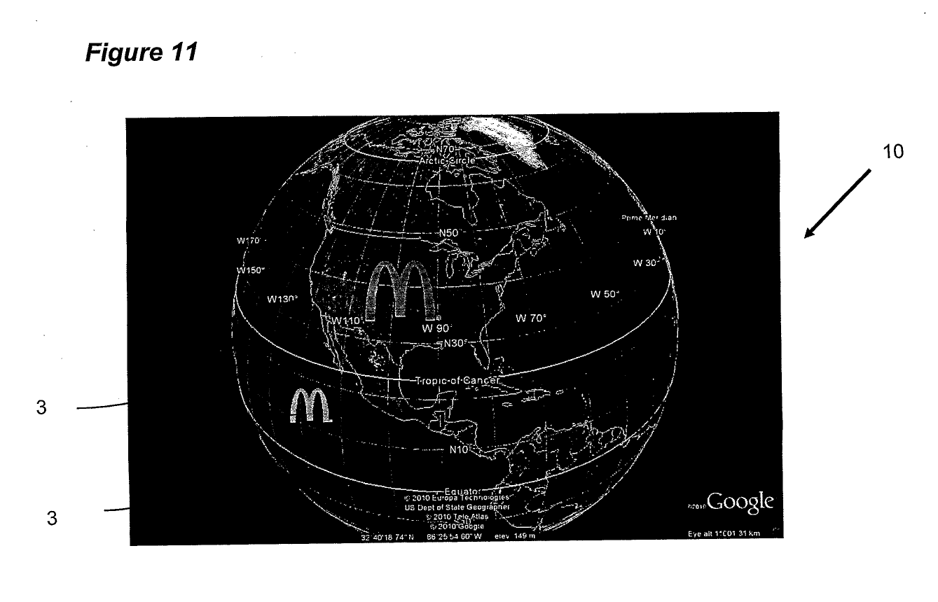

FIG. 11 shows a map of the world 10, with item 3, the invention of two trade marks shown. This is to exemplify that at least one, or any amount of trade marks, or representations could be shown.

As per all examples referred to herein in this document, the representation can be superimposed over the image of space, and Internet link embedded [or formatted via known methods in the industry] to the trade mark so that when a user moves the mouse over the trade mark, it can move, or a pop up menu, may appear, showing options for user to click on and go to, or simply clicking on the initial trade mark could take the user straight to the designated web site address.

As previously referred to, with all of these examples in this document, the invention, for example the representation of item 3, could have a pop up or directional system dependent on scrolling cursor over it, leading to choices or browsing, or it could have embedded in it a direct hyperlink, or link so that a user will be directly connected to designated web site address/s.

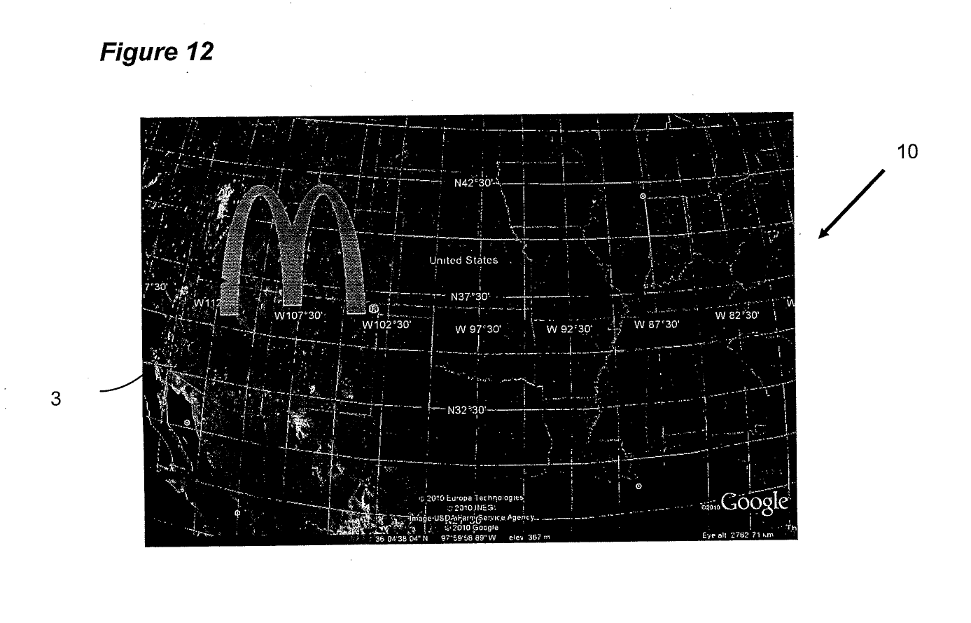

FIG. 12 shows a map 10, and the invention 3. This is to further exemplify that the size and location of the invention can be of any design parameters as desired.

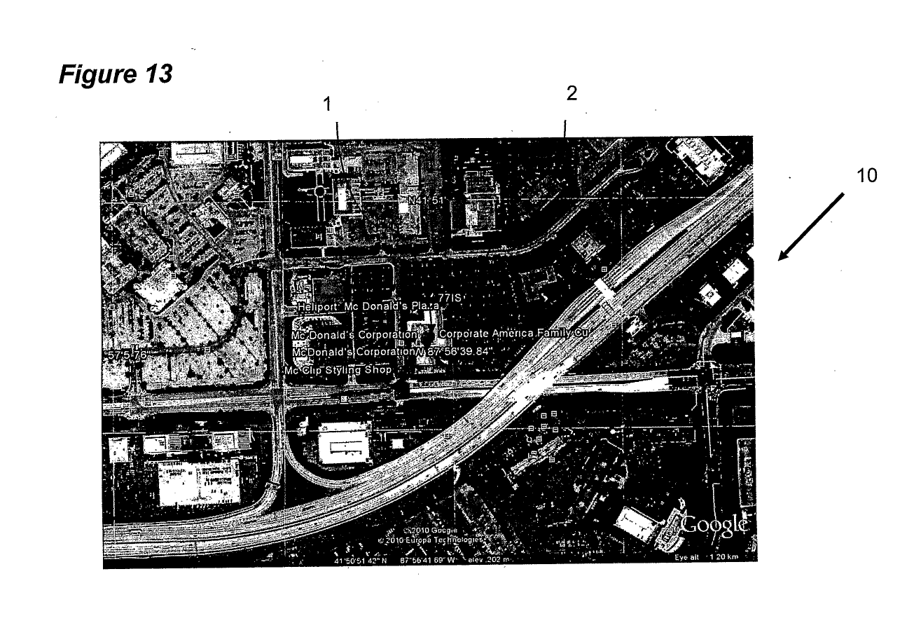

FIG. 13 shows a map 10, with item 1 pointing at least generally towards an area for McDonald's headquarters, and item 2, a further area near such headquarters.

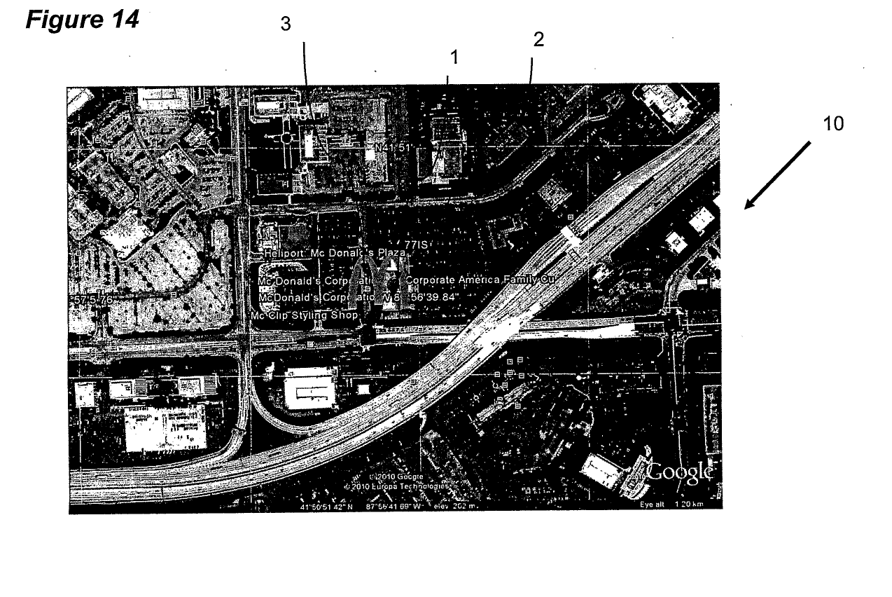

FIG. 14 shows essentially the same map and details and FIG. 13, however, this FIG. 14 includes the invention, item 3. In this way, the invention can allow a browser to click onto that item 3, and as previously referred to, be directed to, for example, a pop up menu, or web site for McDonald's, and at the same time, the representation of the trade mark can add great emphasis to the commerce of such company.

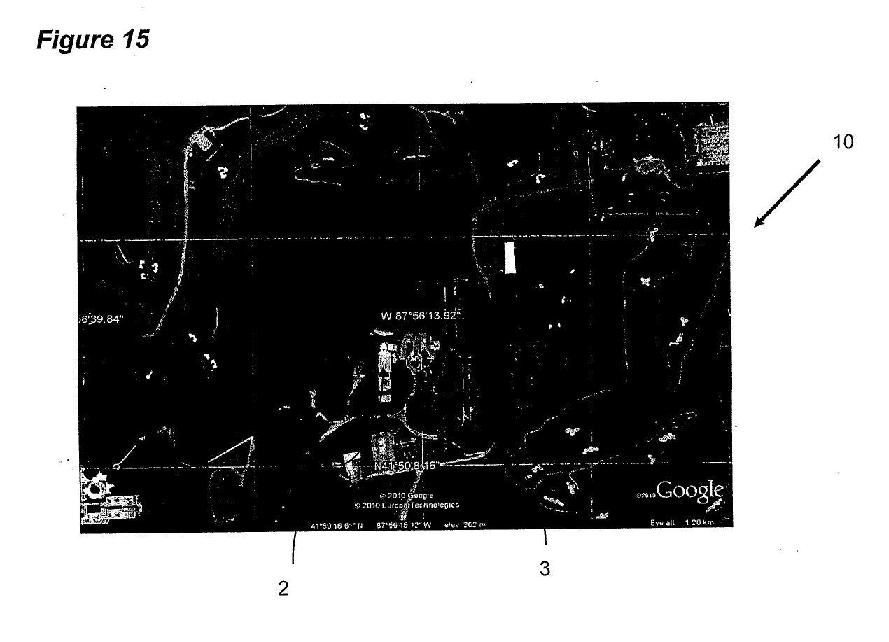

FIG. 15 shows an example of a map 10, with a location at item 2, which can include its surrounding areas. Item 3 shows the invention, whereby the owner of rights relating to such property could charge a fee for the inclusion of the representation, in this case, the trade mark as shown at 3.

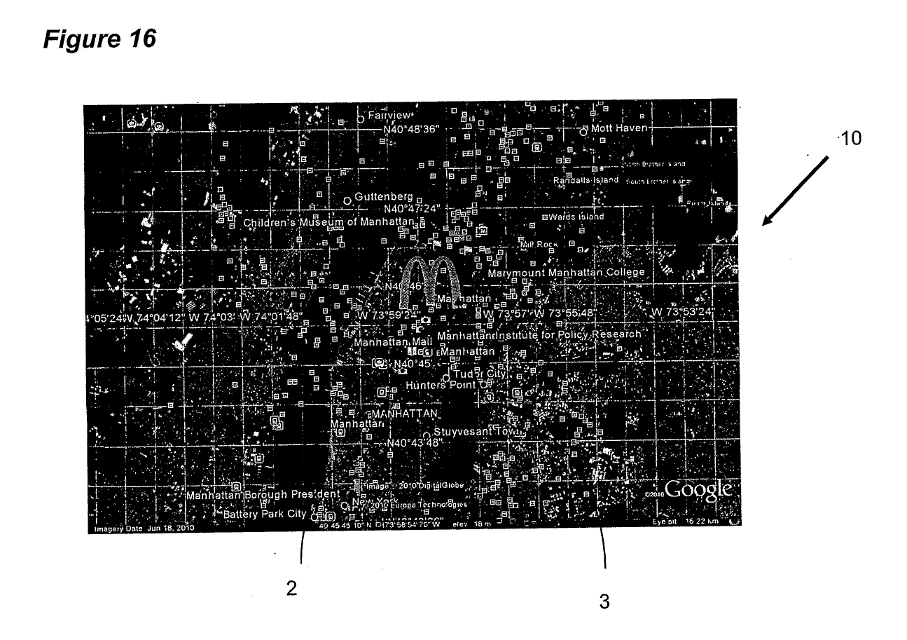

FIG. 16 shows a map 10, of Manhattan, with an area of the city 2, and the invention 3, superimposed over the city.

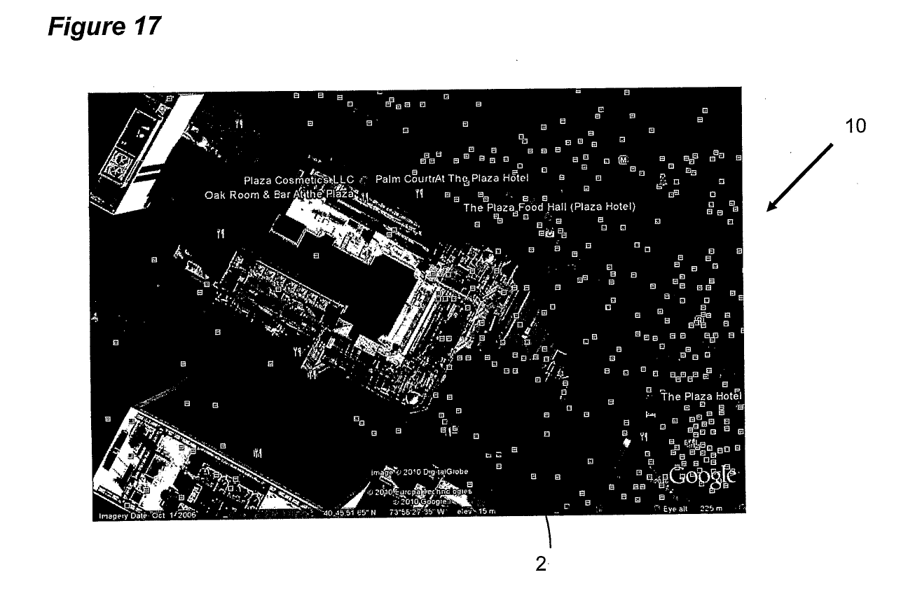

FIG. 17 shows a map 10, of a building 2 in Manhattan, known as The Plaza.

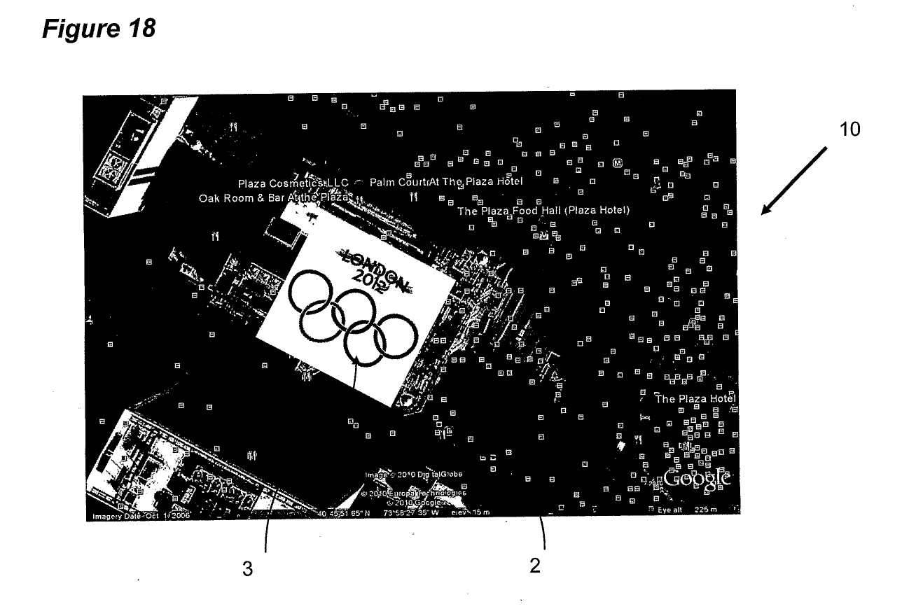

FIG. 18 shows a map 10, essentially the same as FIG. 17, however, with the inclusion of the invention 3, in this case, being a representation, the example being the trade mark for the 2012 Olympics in London.

In this way, the Plaza could charge a fee, for example, for the advertising and with a hyperlink embedded, which could take a browser to a designated website related to the 2012 Olympics. As previously referred to, there could also be a pop up item that gives a browser option as to where to go from there, gain information, and so on.

This further exemplifies that the location of the representation is not necessarily related to the final or only site or information at which the representation represents or is located.

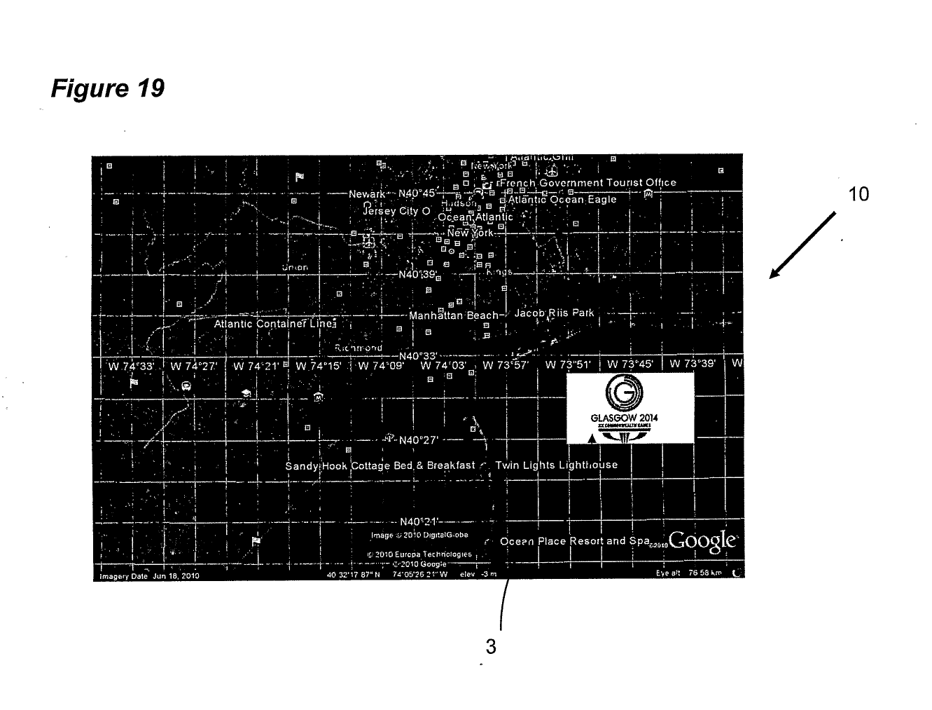

As a further example, FIG. 19 shows a map 10, with the invention 3, being the Glasgow 2014 Commonwealth Games trade mark. This example shows item 3 being in water space, to further exemplify that the invention 3, can be in any location of the world, or out of this world.

To clarify this, this patent and invention includes coverage over space, other planets, items, bodies or matter not defined as Earth. For example, the invention 3, as described, could be applied to any parts of outer space, other planets or items, and to use a local example, the moon.

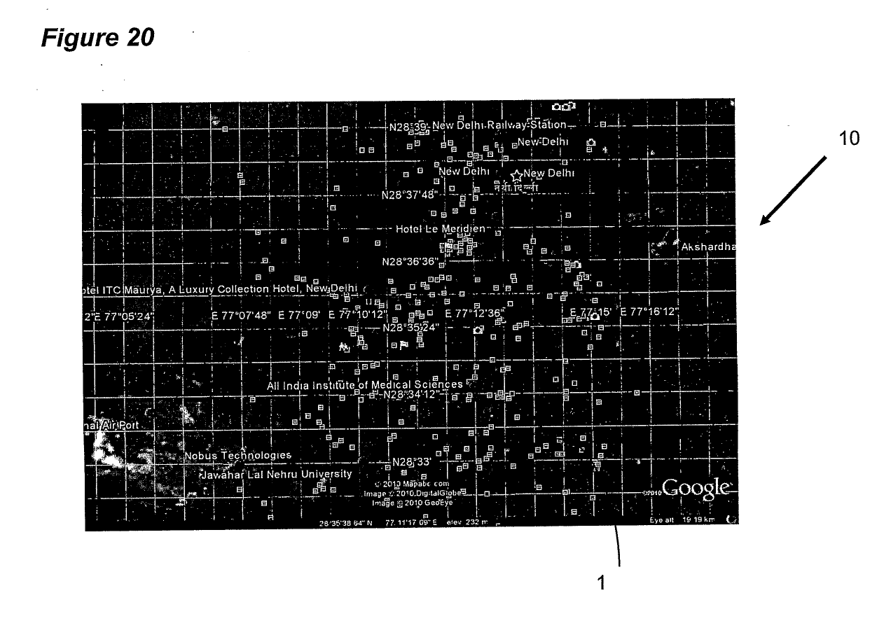

FIG. 20 shows a map 10, of New Delhi, India, with item 1 showing a potential area for a localised application of a representation of the invention, current in theme, such as the 2010 Commonwealth Games.

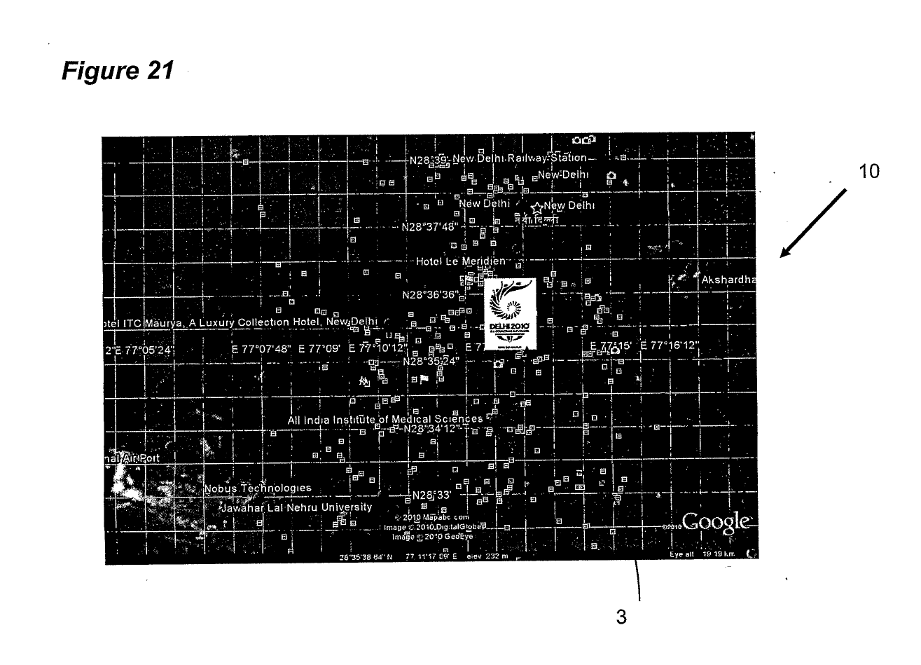

FIG. 21 shows essentially the same map 10, as that shown in FIG. 20, however, with the inclusion of the invention 3, being the trade mark for the New Delhi Commonwealth Games 2010.

Of course, this item 3 can be placed at other locations on the map 10, however, in this case it can be a direct locator for a browser as to where the Games are held, and further, giving prominence to same.

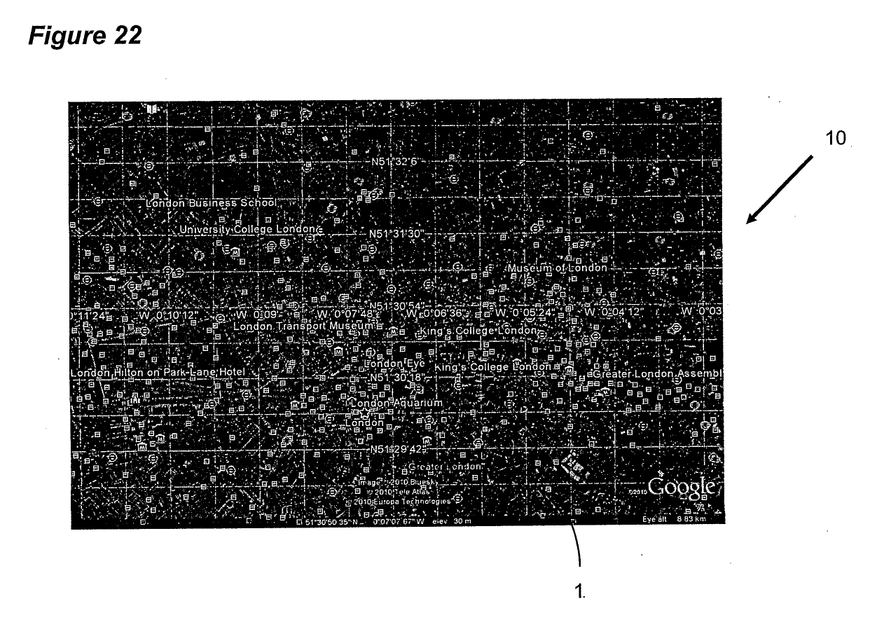

FIG. 22 shows a map 10, of an area of England, London. Item 1 shows a potential site for the invention to be placed.

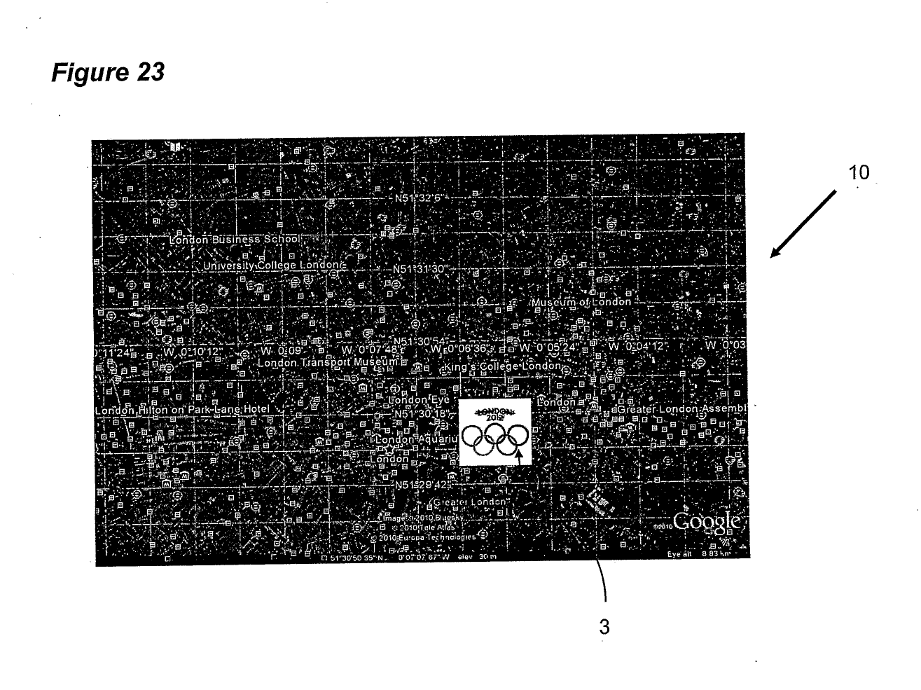

FIG. 23 shows a map 10, at least similar to that of FIG. 22, whereas this FIG. 23 has the invention 3 at the potential site as shown in FIG. 22.

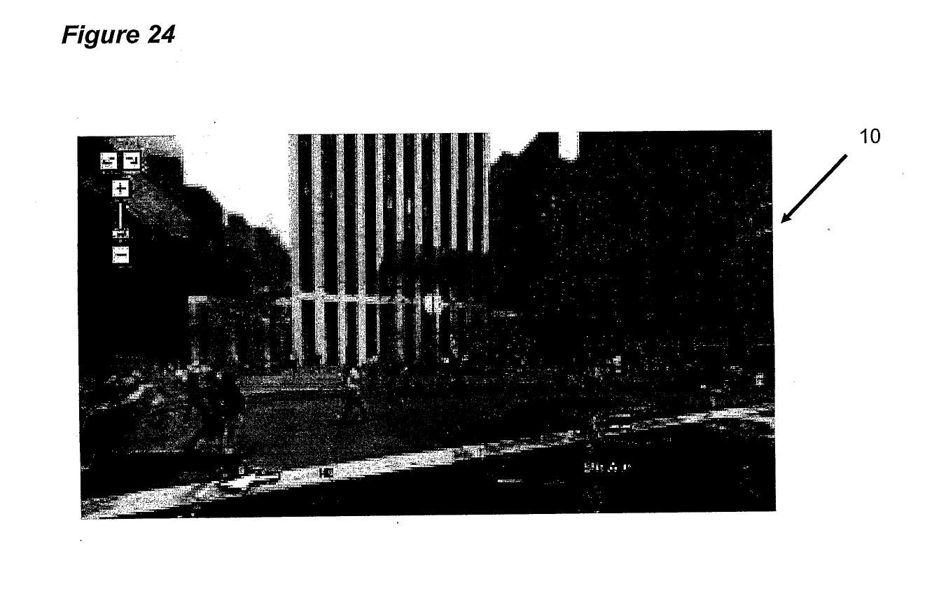

FIG. 24 shows a map 10, such image being via Google Street view.

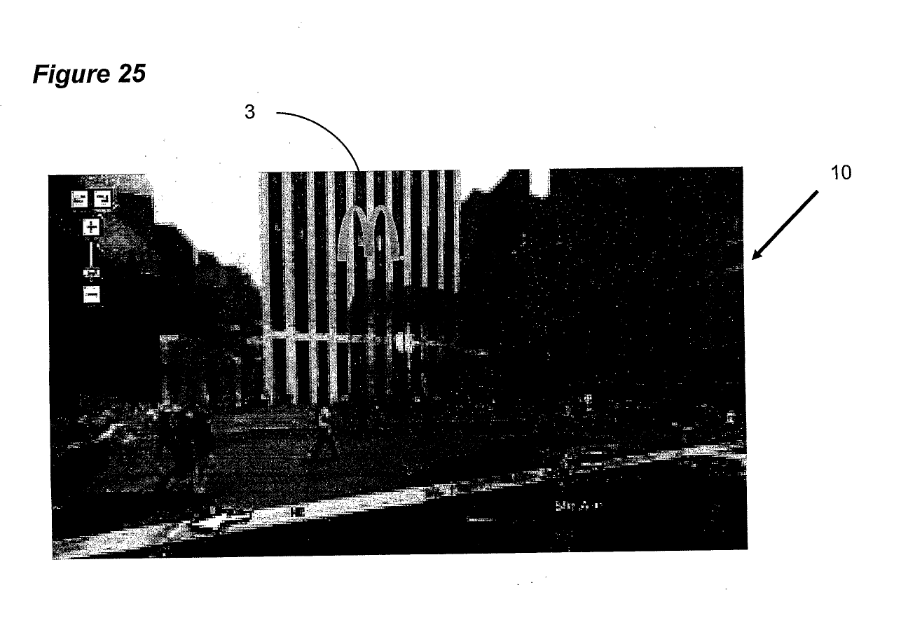

FIG. 25 shows a map 10, at least similar to that of FIG. 24, whereas this FIG. 25 has the invention 3 on a structure, whereby such structure does not normally have such trade mark. This is shown to exemplify that the representation 3, trade mark, can be used in any desired location on maps. As referred to herein, by interacting with 3, an entity can obtain or be presented with more information, or for example, be directed to a web site, and so on, as described herein.

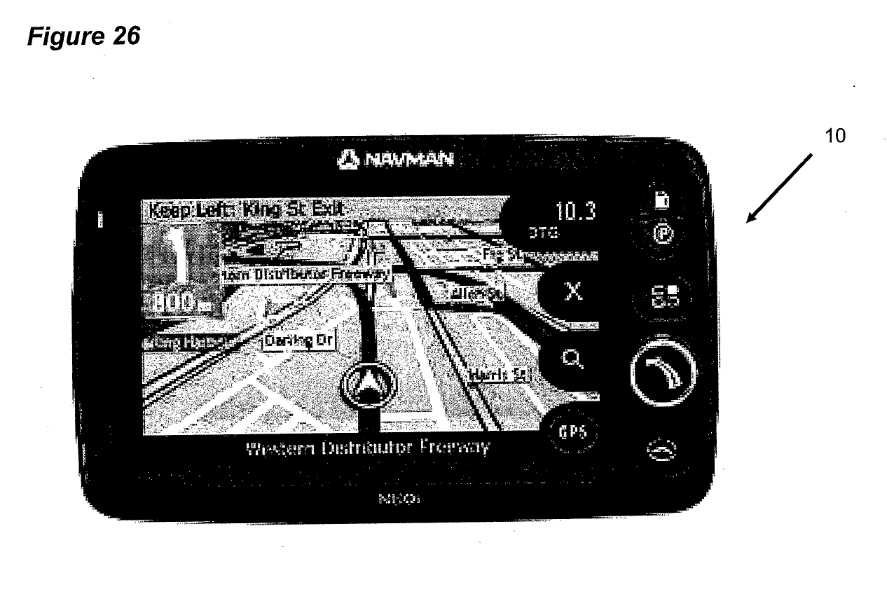

FIG. 26 shows a map 10, such image being via Navman.

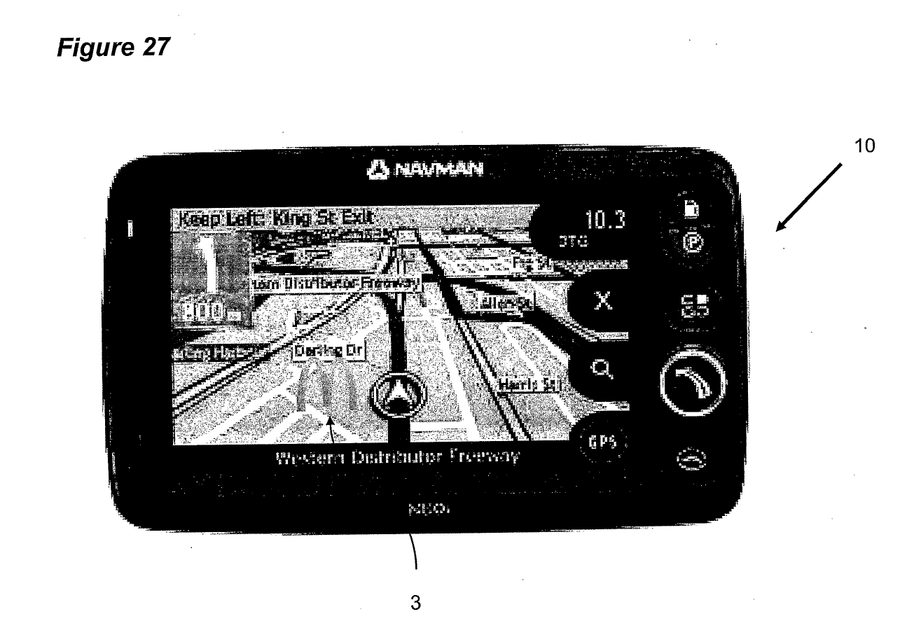

FIG. 27 shows a map 10, at least similar to that of FIG. 26, whereas this FIG. 27 has the invention 3 on the map, whereby map does not normally have such trade mark. This is shown to exemplify that the representation 3, trade mark, can be used in any desired location on maps. As referred to herein, by interacting with 3, an entity can obtain or be presented with more information, or for example, be directed to a web site, and so on, as described herein.

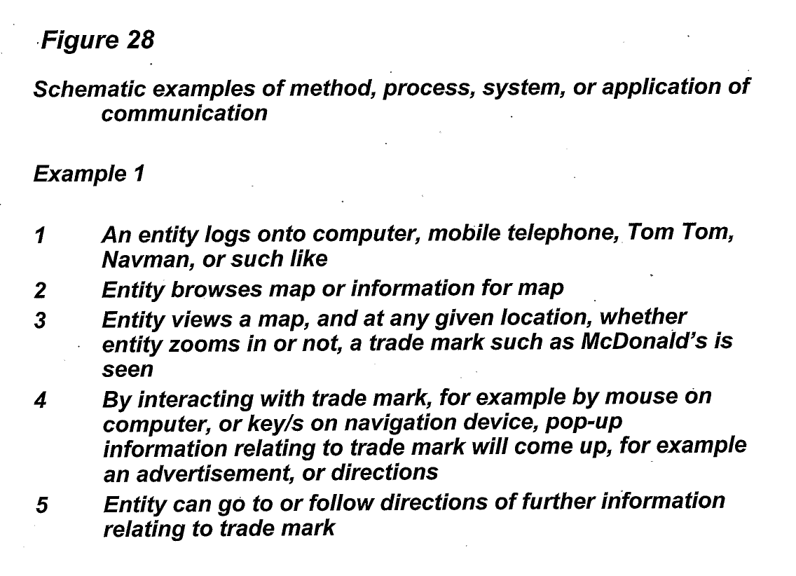

FIG. 28 shows Schematic examples of method, process, system, or application of communication.

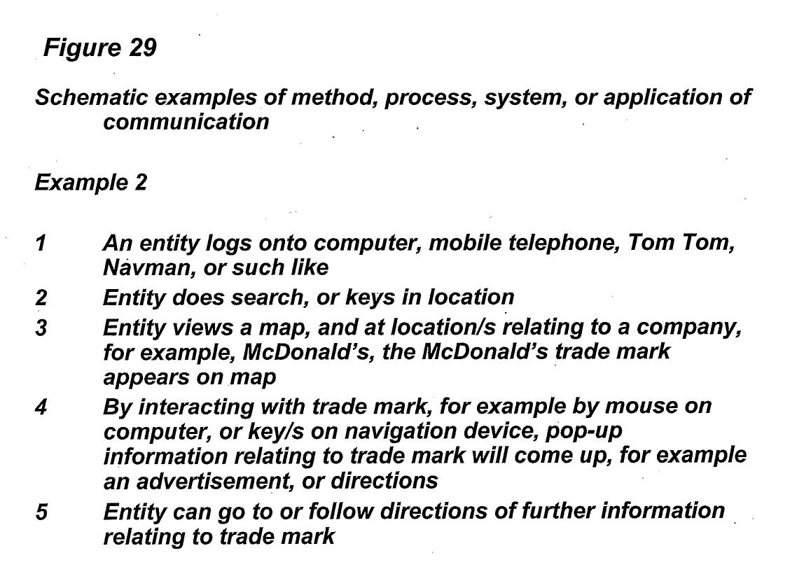

FIG. 29 shows further Schematic examples of method, process, system, or application of communication.

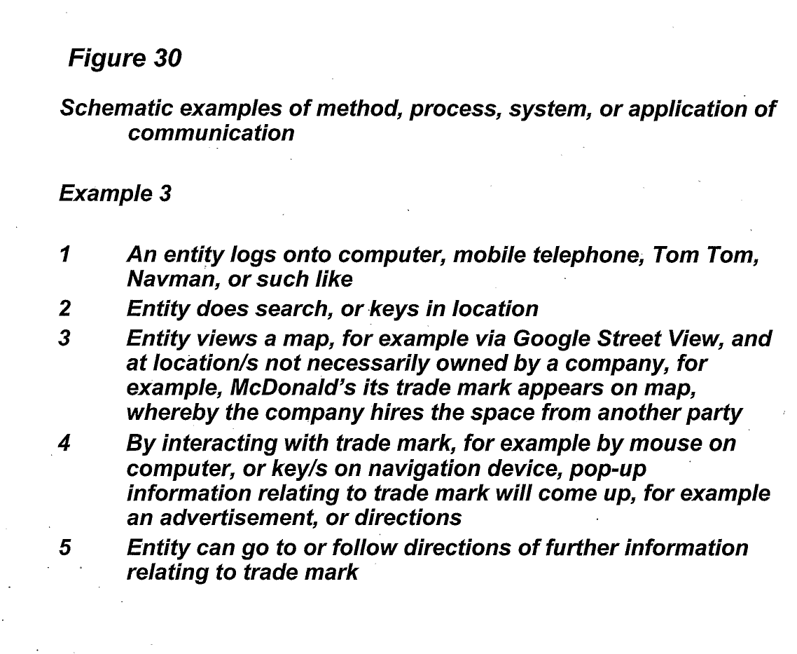

FIG. 30 shows further Schematic examples of method, process, system, or application of communication.

Some further points to note regarding the invention include changing or visual aspects of the representation. This can include making a trade mark, for example, transparent to degrees chosen, or being opaque, so as to work well with the design and visual unity of the overall image.

Further, a system and method could be employed whereby a browser in the USA of a map, of for example Manhattan, could view a particular sight or representation 3 as exemplified, whereas, at the same time, a viewer from another area, such a London, may see a different sight, due to the invention representation 3 as referred to, being different.

In this way, there can be a multi-layered set up of information available to viewers of information, and the same location could have different information relating to it at the same time when viewed from different locations or perspectives. In this way, localised and pertinent information relating to viewer or browser can be tailored for directions to further information, such as pop ups and web site directions as previously referred to.

Also, for clarification, further, any type of map, location, or distance related viewing systems, devices, mechanisms, or applications, can be used for this invention, including mediums of print, photograph, Satellite, Electronic, Internet, Computer, Telephone, Mobile Telephone, Google Earth, Google Maps, Google Maps Street View, Navman Car GPS, Tom Tom GPS Navigation, or such like.

Also, for clarification, any reference to ‘click’ with reference to internet links or computer use, must be read on to mean ‘double click’, touch screen, key or pad use, proceed to next stage, or whatever the case may be to proceed from a position to another, for example, clicking on an icon or representation that would then direct to another action, such as a web site introduction, pop up or such like.

Since modifications within the spirit and scope of the invention may be readily effected by persons skilled in the art, it is to be under stood that this invention is not limited to the particular embodiments described by way of example hereinabove.

In this document, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1: A method, process, system or application of communication wherein a map or representation of a map has a representation such as a trade mark or service mark included on map or representation of map.

2: A method, process, system or application of communication of claim 1, wherein the map or representation of map can be or relate to any type, form, or system.

3: A method, process, system or application of communication of claim 2, wherein the map or representation of map can include such mediums as representational, navigational, illustrative, photo realistic, hyper realistic, virtual, three dimensional, printed, real, non-real, or otherwise.

4: A method, process, system or application of communication of claim 3, wherein the map or representation of map can include any form, type or system, including such any mediums such as print, photograph, Satellite, Electronic, Internet, Computer, Telephone, Mobile Telephone, Google Earth, Google Maps, Google Maps Street View, Navman Car GPS, Tom Tom GPS Navigation, or such like.

5: A method, process, system or application of communication of claim 4, wherein the representation can be any type or amount, or size, of trade mark or a service mark.

6: A method, process, system, or application of communication of claim 5, wherein, the representation can be a service mark, or trade mark, of any type or form.

7: A method, process, system, or application of communication of claim 6, wherein the representation can have relation to further information.

8: A method, process, system, or application of communication of claim 7, wherein the representation can be interactive, and can relate to further information which can include a designated website, or sites, advertising material, pop-up material, or other information, and wherein representation is integrated into map representation via embedding, using hyperlink, or any other integration system.

9: A method, process, system, or application of communication of claim 8, wherein the representation further information can be a obtained by interacting with representation, for example via scrolling or clicking mouse on, voice activation, mouse pad, key use, touch screen, or any other system.

10: A method, process, system, or application of communication of claim 9, wherein the representation can be located at any location, including Earth, such as an area of ocean, land airspace, property, buildings, houses, or any matter relating to Earth; and any matter, material, space, property which is not Earth, such as the Moon, another planet, or space.

11: A method, process, system, or application of communication of claim 10, wherein the representation is not necessarily at the exact headquarters location of the organization being represented.

12: A method, process, system, or application of communication of claim 11, wherein the representation can be positioned on any other part of space or body or matter not classed as Earth.

13: A method, process, system, or application of communication of claim 12, wherein, the representation can be in space.

14: A method, process, system, or application of communication of claim 13, wherein the representation is apparent from any apparent distance.

15: A method, process, system, or application of communication of claim 14, wherein the representation can be positioned over at least part of a country, region, property, or area or mass.

16: A method, process, system, or application of communication of claim 15, wherein the representation can be a vector image, or at least an image that may change with a form of proportion as a user comes closer in apparent perspective to same.

17: A method, process, system, or application of communication of claim 9, wherein the representation indicated on map or map representation, may represent an outlet relating to product or service related to representation.

18: A method, process, system, or application of communication wherein the representation such as a trade mark or service mark can be represented on a map or a representation of a map, wherein the map or representation of map can be of any type or form, and include such any mediums such as print, photographic, Satellite, Electronic, Internet, Computer, Telephone, Mobile Telephone, Google Earth, Google Maps, Google Maps Street View, Navman Car GPS, Tom Tom GPS Navigation, or such like, and the representation can be at any location, at any size, in any duplication, at any represented space or matter, including Earth, and or non or Earth space, matter, material, or otherwise, and optionally wherein, an interactive system with the representation can lead to further information, such as a designated website, a pop-up menu, and/or further information, and wherein interactive system can be achieved by representation being embedded, or use or hyperlink, or any other interactive system.

19: A method, process, system, or application of communication of claim 18, wherein the location of the representation relates to the location of a product, goods or service.

20: A method, process, system, or application of communication wherein the representation such as a trade mark or service mark can be represented on a map or a representation of a map, wherein the map or representation of map can be of any-type or form, and can include such any mediums such as print, photographic, Satellite, Electronic, Internet, Computer, Telephone, Mobile Telephone, Google Earth, Google Maps, Google Maps Street View, Navman Car GPS, Tom Tom GPS Navigation, or such like, and the representation can be at any location, at any size, in any duplication, at any represented space or matter, including Earth, and or non or Earth space, matter, material, or otherwise, wherein the location of the representation does not relate to the location of a product, goods or service, and as such, the representation space may be utilized by a further party, and optionally wherein, an interactive system with the representation can lead to further information, such as a designated website, a pop-up menu, and/or further information, and wherein interactive system can be achieved by representation being embedded, or use or hyperlink, or any other interactive system.

21. (canceled)
